(19) United States
(12) Patent Application Publication
(10) Pub. No.: US 2013/0009892 A1
(43) Pub. Date: Jan. 10, 2013

(54) METHODS AND APPARATUSES FOR PROVIDING HAPTIC FEEDBACK

(75) Inventor: Mika Allan Salmela, Oulu (FI)

(73) Assignee: Nokia, Inc., Espoo (FI)

(21) Appl. No.: 13/541,975

(22) Filed: Jul. 5, 2012

Related U.S. Application Data
(63) Continuation-in-part of application No. 13/177,917, filed on Jul. 7, 2011.

(51) Int. Cl. G08B 6/00; G06F 3/041

(52) U.S. Cl. 345/173

(57) ABSTRACT

Methods and apparatuses are provided for facilitating control of haptic feedback. A method may include receiving an indication of flexing of a flexible display. The method may further include causing, in response to flexing of the flexible display, activation of a haptic actuator. The method may include determining a degree of flexing of the flexible display. The method may further include causing activation of the haptic actuator in an instance in which a threshold has been satisfied. Corresponding apparatuses and computer program products are also provided.

### CROSS-REFERENCE TO RELATED APPLICATIONS

This application is a continuation-in-part application of U.S. application Ser. No. 13/177,917 filed Jul. 7, 2011, currently pending, the entire disclosure of which is hereby incorporated herein by reference.

### TECHNOLOGICAL FIELD

Example embodiments of the present invention relate generally to user interface technology and, more particularly, relate to methods and apparatuses for providing haptic feedback.

### BACKGROUND

The modem communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modem networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

As a result of the expansion of networks and mobile computing devices using networks, there is a vast amount of content available for access by computing device users. This content may be stored locally on a user's computing device and/or may be accessible via a network from a server or other content source. In order to interact with or otherwise access this content, it may be necessary to navigate through the content with a user interface, such as a touch screen user interface. Various techniques have been developed in order to facilitate navigation via a user interface. For example, haptic feedback may be utilized to assist a user when navigating through content via a user interface, such as a touch screen user interface.

### BRIEF SUMMARY

Methods, apparatuses, and computer program products are herein provided for facilitating control of haptic feedback. Methods, apparatuses, and computer program products in accordance with various embodiments may provide several advantages to computing devices and computing device users. The method, apparatus, and computer program product of one example embodiment also provides a user with the ability to control haptic feedback by receiving an indication of flexing of a flexible display and causing, by a processor and in response to flexing of the flexible display, activation of a haptic actuator. In a first example embodiment, a method is provided, which comprises receiving an indication of flexing of a flexible display. The method further comprises causing, by a processor and in response to flexing of the flexible display, activation of a haptic actuator.

In another example embodiment, an apparatus comprising at least one processor and at least one memory storing computer program code is provided. The at least one memory and stored computer program code are configured, with the at least one processor, to cause the apparatus of this example embodiment to at least receive an indication of flexing of a flexible display. The at least one memory and stored computer program code are configured, with the at least one processor, to further cause the apparatus of this example embodiment to at least cause, in response to flexing of the flexible display, activation of a haptic actuator.

In another example embodiment, a computer program product is provided. The computer program product of this example embodiment includes at least one non-transitory computer-readable storage medium having computer-readable program instructions stored therein. The computer-readable program instructions of this example embodiment comprise program instructions configured to cause an apparatus perform a method comprising receiving an indication of flexing of a flexible display and causing, in response to flexing of the flexible display, activation of a haptic actuator. In a further example embodiment, an apparatus is provided which comprises means for receiving an indication of flexing of a flexible display. The apparatus of this embodiment further comprises means for causing, in response to flexing of the flexible display, activation of a haptic actuator.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus for facilitating control of haptic feedback according to an example embodiment;

FIG. 2 is a schematic block diagram of a mobile terminal according to an example embodiment;

FIG. 3 illustrates an example user interface for facilitating control of haptic feedback according to an example embodiment;

FIG. 4 illustrates interaction with an example user interface of a flexible display for facilitating control of haptic feedback according to an example embodiment; and

FIG. 5 illustrates a flowchart according to an example method for controlling haptic feedback according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of computer-readable media include a floppy disk, a flexible disk, hard disk, magnetic tape, any other magnetic medium, a compact disc read only memory (CD-ROM), compact disc compact disc-rewritable (CD-RW), digital versatile disc (DVD), Blu-Ray, any other optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Various example embodiments disclosed herein may provide several advantages to computing devices and computing device users. For example, some example embodiments may facilitate control of haptic feedback to assist with user interface navigation at least substantially with use of flexing inputs to a flexible display and touch gestures in conjunction with haptic actuators, such that a need for WIMP (windows icons menus pointer) input devices may be eliminated in some example embodiments. Accordingly, a need for some wired and/or wireless peripheral devices may be eliminated in some example embodiments. As such, example computing devices in accordance with some example embodiments may benefit from reduced size and/or a more streamlined user interface than computing devices requiring a WIMP input device. Further, navigation through content in accordance with the user interface of some example embodiments may require less time and/or effort than with traditional WIMP user interfaces and/or traditional touch input user interfaces. Further, navigation through content in accordance with the user interface of some example embodiments may produce fewer erroneous user inputs than with traditional WIMP user interfaces and/or traditional touch input user interfaces.

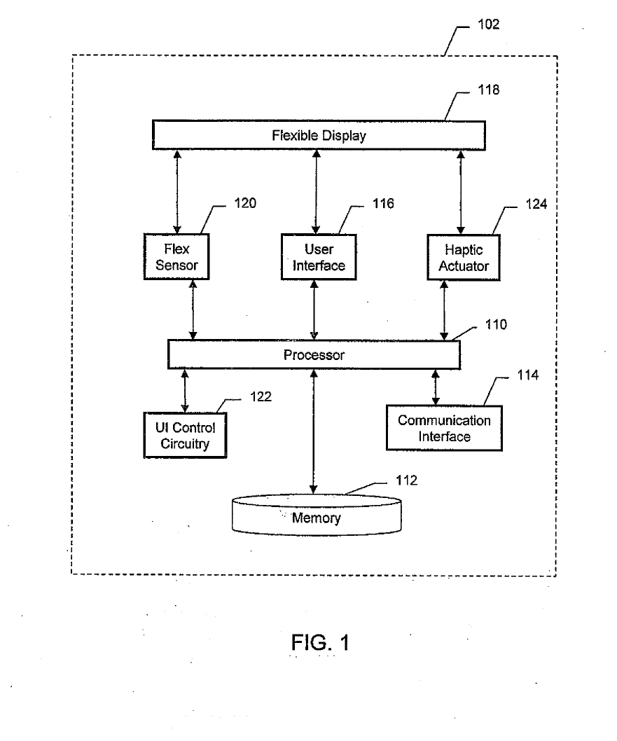

FIG. 1 illustrates a block diagram of an apparatus 102 for facilitating control of haptic feedback to assist with user interface navigation according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating control of haptic feedback to assist with user interface navigation, other configurations may also be used to implement embodiments of the present invention.

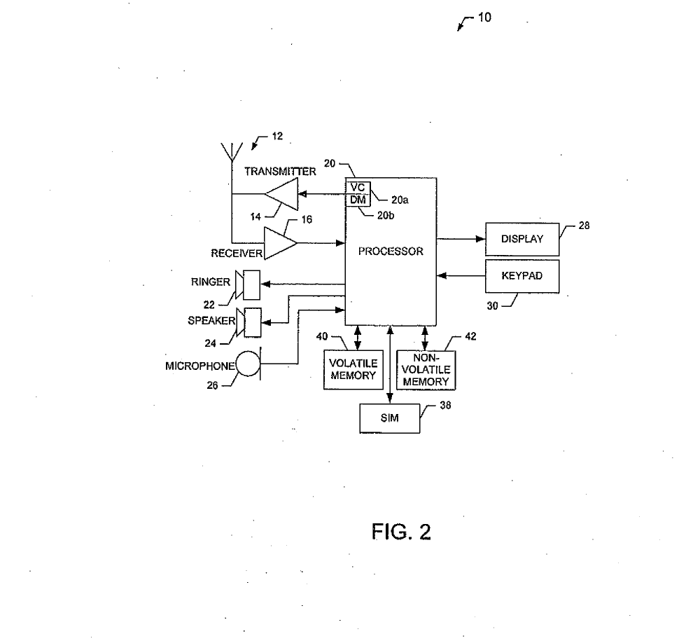

The apparatus 102 may be embodied as a desktop computer, laptop computer, mobile terminal, mobile computer, mobile phone, mobile communication device, game device, digital camera/camcorder, audio/video player, television device, radio receiver, digital video recorder, positioning device, electronic paper (e-paper), a chipset, a computing device comprising a chipset, any combination thereof, and/or the like. In this regard, the apparatus 102 may comprise any computing device that comprises or is in operative communication with a flexible display. In an example embodiment, the apparatus 102 is embodied as a mobile computing device, such as a mobile terminal, such as that illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a flexible touch display, such as a flexible OLED display. The user input interface may comprise devices allowing the mobile terminal to receive data, such as a keypad 30, a flexible touch display (e.g., some example embodiments wherein the display 28 is configured as a flexible touch display), a joystick (not shown), and/or other input device. In embodiments including a keypad, the keypad may comprise numeric (0-9) and related keys (#, *), and/or other keys for operating the mobile terminal.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40, non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, flexible display 118, flex sensor 120, user interface control circuitry 122, or haptic actuator 124. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, and/or user interface control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42. The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, service data, and/or the like. This stored information may be stored and/or used by the user interface control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, user interface control circuitry 122, and/or haptic actuator 124, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some example embodiments, the user interface 116 comprises or is in communication with one or more displays, such as the flexible display 118. In embodiments wherein the user interface 116 comprises or is in communication with a touch screen display (e.g., in embodiments wherein the flexible display 118 is embodied as a touch screen display), the user interface 116 may additionally be configured to detect and/or receive an indication of a touch gesture or other input to the touch screen display. The user interface 116 may be in communication with the memory 112, communication interface 114, flexible display 118, flex sensor 120, user interface control circuitry 122, and/or a haptic actuator 124, such as via a bus.

In some example embodiments, the apparatus 102 comprises a flexible display 118. In alternative example embodiments, such as in embodiments wherein the apparatus 102 is embodied as a chip or chipset, the apparatus 102 may be operatively connected with the flexible display 118 such that the apparatus 102 may control the flexible display 118, receive an indication of and/or otherwise determine a user input (e.g., a flexing input, a touch gesture input, and/or the like) to the flexible display 118, and/or the like. The flexible display 118 may comprise any type of display that may be flexed. By way of non-limiting example, the flexible display 118 may comprise an organic light-emitting diode display (OLED). However, it will be appreciated that the flexible display 118 may be embodied as any type of display that may be flexed. In one example embodiment, the flexible display 118 may comprise a flexible touch screen display. In such example embodiments, the flexible display 118 may be in communication with the user interface 116 to enable detection of a touch gesture input to the flexible display 118. The flexible display 118 may additionally or alternatively be in communication with one or more of the processor 110, memory 112, communication interface 114, flex sensor 120, user interface control circuitry 122, or haptic actuator 124, such as via a bus.

The flex sensor 120 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In embodiments wherein the flex sensor 120 is embodied separately from the processor 110, the flex sensor 120 may be in communication with the processor 110. In some example embodiments, the flex sensor 120 is in communication with or is otherwise in operative contact with the flexible display 118. In this regard, the flex sensor 120 may be configured to detect a flexing of the flexible display 118 (e.g., detect when the flexible display 118 is in a flexed state). The flex sensor 120 may be further configured to detect a degree of flexing of the flexible display 118. For example, the flex sensor 120 may comprise one or more pressure sensors that may be actuated by flexing of the flexible display 120. As another example, the flex sensor 120 may comprise one or more electrical sensors, one or more mechanical sensors, one or more electromechanical sensors, and/or the like that may be activated in response to flexing of the flexible display 118. The flex sensor 120 may be configured to generate a signal indicative of whether the flexible display 118 is flexed and/or a degree of flexing of the flexible display 118. The flex sensor 120 may be configured to communicate such a signal to the processor 110, communication interface 114, user interface 116, user interface control circuitry 122, and/or a haptic actuator 124. As such, the user interface control circuitry 122 may be configured in some example embodiments to determine flexing of the flexible display 118 and/or a degree of flexing based at least in part on a signal generated by the flex sensor 120. The flex sensor 120 may accordingly be in communication with one or more of the memory 112, communication interface 114, user interface 116, flexible display 118, user interface control circuitry 122, or haptic actuator 124, such as via a bus.

The user interface control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In embodiments wherein the user interface control circuitry 122 is embodied separately from the processor 110, the user interface control circuitry 122 may be in communication with the processor 110. The user interface control circuitry 122 may further be in communication with one or more of the memory 112, communication interface 114, user interface 116, flexible display 118, flex sensor 120, or haptic actuator 124, such as via a bus.

In some example embodiments, the apparatus 102 comprises a haptic actuator 124. In alternative example embodiments, such as in embodiments wherein the apparatus 102 is embodied as a chip or chipset, the apparatus 102 may be operatively connected with the haptic actuator 124 such that the apparatus 102 may control the haptic actuator 124. The haptic actuator 124 may comprise any type of actuator, motor, and/or the like configured to provide tactile feedback, such as textural, vibration, resistance, dampening, and/or the like, feedback to a user. By way of non-limiting example, the haptic actuator 124 may comprise a piezoelectric actuator. For example, the haptic actuator 124 may comprise a plurality of piezoelectric actuators configured to provide a feedback at a particular location on a flexible display 118 of the apparatus 102. Specifically, the haptic actuator 124 may be configured to raise a portion of a flexible display 118 relative to the flexible display 118 by providing a force to the portion of the flexible display 118. However, it will be appreciated that the haptic actuator 124 may be embodied as any type of actuator that provides a force to a user for tactile feedback. In some example embodiments, the haptic actuator 124 may be in communication with the user interface 116 to enable actuation of the haptic actuator in response to a signal provided by the flex sensor 120. In another embodiment, the haptic actuator 124 may be in communication with the flex sensor 120 to enable actuation of the haptic actuator. The haptic actuator 124 may additionally or alternatively be in communication with one or more processor 110, memory 112, communication interface 114, user interface 116, flex sensor 120, or user interface control circuitry 122, such as via a bus.

In some embodiments, the haptic actuator 124 may be an actuator, motor, and/or other mechanical device configured to provide a vibration and/or other tactile feedback to a user. For example, the haptic actuator 124 may be configured to provide a tactile feedback to the user at a location disposed near a flexible display 118 when the user provides an input to the flexible display 118. Specifically, the user may provide a touch input to the flexible display 118 to indicate a selection of a graphical user interface object displayed upon the flexible display, and the haptic actuator 124 may be configured to provide a vibration located proximate to the graphical user interface object and/or the location of the touch input provided by the user. In some embodiments, the haptic actuator 124 may comprise a plurality of actuators, motors, and/or the like. Accordingly, the haptic actuator 124, in conjunction with one or more processor 110, may be configured to activate a particular actuator, motor, and/or the like at a specific location, such as at a location of a touch input provided by a user and/or a location proximate to a selected graphical user interface object.

According to some embodiments, the haptic actuator 124 may be configured to provide a textural, vibration, resistance, dampening, and/or the like, feedback to a user. For example, the haptic actuator 124 may be configured to provide a textural feedback to a user. Specifically, the haptic actuator 124 may be configured to provide a feedback to a user corresponding to the actual texture of an object displayed on the apparatus 102. The flexible display 118 may be configured to display an object having a smooth texture, such as a glass object. Accordingly, the haptic actuator 124 may be configured to provide the user with a tactile feedback simulating the smooth texture of the glass object. In another embodiment, the flexible display 118 may be configured to display an object having a rough and/or course texture, such as sandpaper, and the haptic actuator 124 may be configured to provide the user with a tactile feedback simulating the rough and/or course texture of the sandpaper.

In another embodiment, the haptic actuator 124 may be configured to provide a resistance feedback. The haptic actuator 124 may be configured to provide a resistance feedback that opposes a user manipulation in a real and/or simulated manner. For example, the haptic actuator 124 may be configured to provide a resistance feedback that opposes a user's touch input, such as a push, swipe, and/or the like input. In some embodiments, the resistance feedback may cause the user to exert additional force to complete the desired touch input. For example, the flexible display 118 may be configured to display a graphical user interface object, such as a slidable switch, upon the flexible display 118. As such, the haptic actuator 124 may be configured to provide a tactile feedback simulating resistance as the user slides the switch from a first position to a second position. According to some embodiments, the haptic actuator 124 may be configured to provide a resistance feedback to a user, such as a feedback of increasing texture, when the user slides the switch from a first position to a second position causing the sliding motion to become increasingly difficult as the user slides the switch from the first position to the second position. In some embodiments, the haptic actuator 124 may be configured to provide a resistance feedback, such as a force, to the flexible display 118 proximate to a graphical user interface object, such as a slidable switch. For example, the haptic actuator 124 may include a plurality of actuators disposed proximate to the flexible display 118. The plurality of actuators may be disposed proximate to one end of a slidable switch to an opposite end of a slidable switch displayed upon the flexible display 118. A user may provide a sliding touch input sliding the switch from a first position to a second position. As such, a first plurality of actuators may be configured to provide a minimal amount of force upon the flexible display 118 proximate to the first position. As the user provides the sliding touch input, at least a second plurality of actuators disposed proximate to the second position may provide a force to the flexible display 118 greater than the first minimal force. Accordingly, as the user provides a sliding touch input, the actuators may be configured to provide an increasing force to the flexible display 118 from the first position to the second position as the user provides the sliding touch input to the flexible display 118. In another embodiment, the haptic actuator 124 may be configured to provide a resistance feedback, such as a force, to the flexible display 118 proximate to a graphical user interface object, such as a button. Specifically, when the user provides a touch input to the flexible display 118 proximate the graphical user interface object indicating a selection and an activation of the button, the haptic actuator 124 may be configured to provide an upward force proximate the graphical user interface object in a direction opposite of the downward movement of the touch input provided by the user.

In other embodiments, the haptic actuator 124 may be configured to provide a dampening feedback. In some embodiments, the haptic actuator 124 may be configured to provide a tactile feedback with a decreasing and/or lesser intensity than a tactile feedback previously provided to a user. For example, the haptic actuator 124 may comprise a plurality of actuators, motors, and/or the like. As such, the haptic actuator 124, in conjunction with one or more processor 110, may be configured to activate a majority of the actuators, motors, and/or the like of the apparatus 102. In some embodiments, the user may provide a touch input to a flexible display 118 and/or user interface of the apparatus 102. As such, the haptic actuator 124 may be configured to provide a dampening feedback by ceasing the activation of the actuators, motors, and/or the like at a specific location, such as at a location of a touch input provided by a user and/or a location proximate to a selected graphical user interface object. In some embodiments, the haptic actuator 124 may be configured to provide a tactile feedback with decreasing intensity. For example, the user may provide a touch input to a flexible display 118, such as a selection of a graphical user interface object displayed upon the flexible display. The haptic actuator 124 may be configured to provide a first vibration feedback to the user proximate to the graphical user interface object, such as a button. In some embodiments, the user may continue to provide the touch input to the button and the haptic actuator 124 may be configured to provide a second vibration feedback having an intensity less than the first vibration feedback. In another embodiment, the haptic actuator 124 may be configured to provide a first textual feedback, such as a textural feedback corresponding to a course surface displayed upon the flexible display 118. In one embodiment, the user may provide a touch input to the flexible display 118 simulating a back-and-forth motion over the course texture displayed upon the flexible display 118. As the user moves a finger back and forth across the course texture displayed upon the flexible display 118, the flexible display may be configured to display a weathering, deformation, and/or other transformation of the course texture to a smoother texture. Accordingly, the haptic actuator 124 may be configured to provide a textural feedback corresponding to the weathering, deformation, and/or other transformation of the course texture to a smoother texture.

In some example embodiments, the apparatus 102 is embodied in a flexible housing embodying the flexible display 118. In such embodiments, at least a portion of a housing of the apparatus 102 may be flexed along with the flexible display 118. One example of such embodiments is example embodiments wherein the apparatus 102 is embodied as e-paper. Accordingly, where flexing of the flexible display 118 is described herein, it will be appreciated that flexing of the flexible display 118 may comprise flexing of at least a portion of the apparatus 102, flexing of a flexible housing in which the flexible display 118 is embodied or the like. Alternatively, in other example embodiments, the flexible display 118 may be housed within a rigid housing. In such example embodiments, the flexible display 118 may be flexed within the confines of the housing.

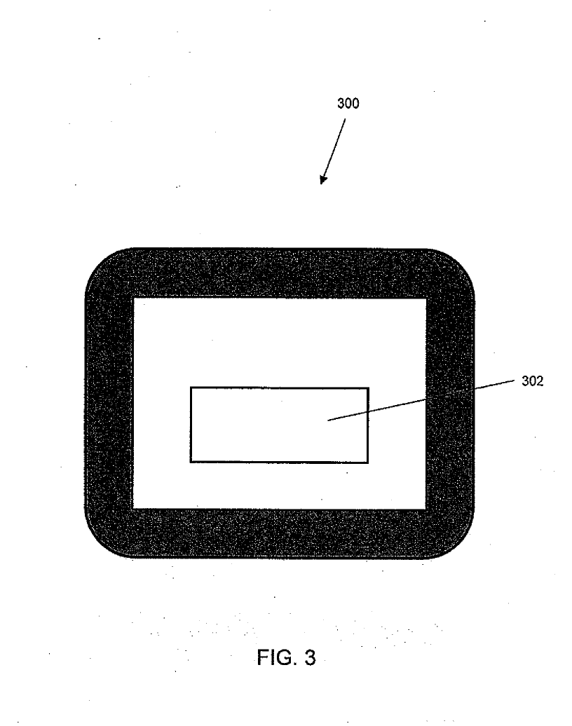

Referring now to FIG. 3, an example user interface 300, such as may be implemented on a flexible touch screen display (e.g., a flexible display 118), for facilitating control of haptic feedback to assist with user interface navigation with at least one haptic actuator is illustrated. The user interface 300 may comprise one or more graphical user interface objects 302, as shown in FIG. 3. A graphical user interface object may comprise a designated touch-sensitive area in which a user may provide a touch input, a touch gesture input and/or the like for initiating navigation of content, navigation of a user interface and/or the like. In some example embodiments wherein the flexible display comprises a touch screen display, one or more graphical user interface objects may be displayed upon one or more portions of the flexible touch screen display. According to one example embodiment of the present invention, a haptic actuator may be configured to provide a force or other feedback to the user at a location substantially near the graphical user interface object 302. In one embodiment, the haptic actuator may be configured to provide textural, vibration, resistance, dampening, and/or other feedback to a user at a location substantially near the graphical user interface object 302 in an instance in which a flex sensor detects a flexing of the flexible touch screen display at a location near or that otherwise includes the graphical user interface object 302. In another example embodiment, the haptic actuator may be configured to provide feedback at a location near or that otherwise includes the graphical user interface object 302 as the graphical user interface object changes locations on the user interface 300. In such an embodiment, a user may provide a touch input, such as a sliding touch input, to move the graphical user interface object from one location on the user interface to at least a second location on the user interface. As such, the haptic actuator may be configured to provide feedback to the user as the user provides the sliding touch input moving the graphical user interface object from the first location to the second location on the user interface. According to one embodiment of the present invention, the haptic actuator may be configured to provide tactile or other feedback upon a user flexing the flexible display either prior to or following actuation of the graphical user interface object 302 by the user. In one embodiment in which the haptic actuator provides feedback upon flexing of the flexible display prior to actuation of the graphical user interface object 302, the haptic feedback may assist the user in identifying or locating the graphical user interface object, thereby potentially increasing the speed with which a user may select a graphical user interface object and/or the accuracy with which a graphical user interface object is selected. In another embodiment in which the haptic actuator provides feedback upon flexing of the flexible display following actuation of the graphical user interface object 302, the haptic feedback may reassure the user that the actuation of the graphical user interface object was registered and will be acted upon.

The example flexible display on which the user interface 300 is illustrated in FIG. 3 is in an unflexed state. In this state, the haptic actuator may be inactive and may not be providing any haptic feedback. In order to control the user interface 300, such as by engaging a graphical user interface object 302, a user may flex the flexible display. Further, in one embodiment, a flexible touch screen display displaying a graphical user interface object 302 may be configured to receive an indication of a touch input upon the graphical user interface object only when the flexible touch screen display has been sufficiently flexed. While the haptic feedback may not be provided until after receipt of the touch input of a graphical user interface object 302 according to one embodiment, a flexible touch screen display displaying a graphical user interface object of another embodiment may be further configured to receive an indication of a touch input upon the graphical user interface object not only once the flexible touch screen display has been sufficiently flexed, but also only when a haptic actuator has provided a textural, vibration, resistance, dampening and/or the like, feedback to a user at a location near the graphical user interface object.

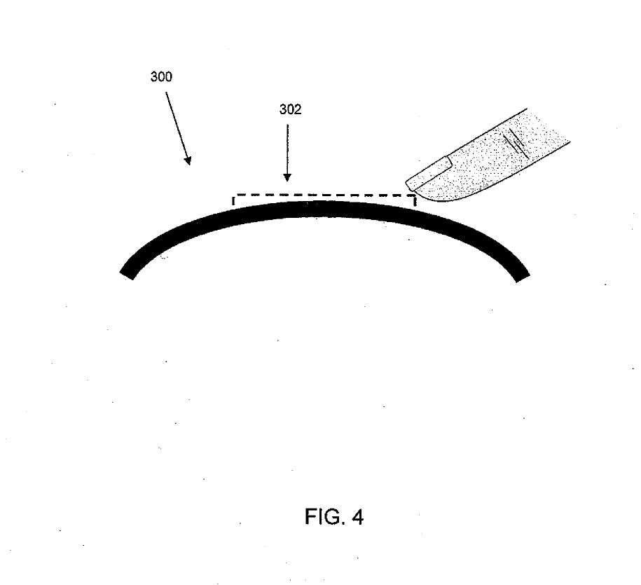

Referring now to FIG. 4, FIG. 4 illustrates interaction with an example user interface of a flexible display for facilitating control of haptic feedback in order to assist with user interface navigation with at least one haptic actuator. In this regard, FIG. 4 illustrates flexing of the flexible display on which the example user interface 300 is implemented. As an example, a flexible display 118 in accordance with some example embodiments may be flexed upward (e.g., toward a user), such as shown in FIG. 4. In other example embodiments, the flexible display may be flexed along another axis or orientation of the flexible display 118 than as illustrated in FIG. 4. For example, a flexible display 118 in accordance with some example embodiments may be flexed along a horizontal or a vertical axis. In another embodiment, a flexible display 118 may be flexed in a concave fashion, rather than a convex fashion (e.g. as illustrated in FIG. 4).

The user interface control circuitry 122 may be configured to receive an indication of flexing of a flexible display 118 and/or otherwise determine flexing of a flexible display 118. In this regard, for example, the flex sensor 120 may be configured to detect flexing of the flexible display 118 and generate a signal indicative of flexing of the flexible display 118. This signal may be received by the user interface control circuitry 122, which may determine flexing of the flexible display in response to receiving the signal. This signal may carry information indicative of one or more properties of the flexing, such as a degree of flexing, thereby enabling the user interface control circuitry 122 to determine a degree and/or other property of the flexing and, based at least in part thereof, control the actuation of a haptic actuator. The user interface control circuitry 122 may be configured to cause haptic feedback to be provided to a user of the apparatus 102 in response to flexing of the flexible display 118, either prior to or following a user input. In either instance, the apparatus 102 of one embodiment may include means, such as the haptic actuator 124, the processor 110 or the like, configured to provide different amounts of haptic feedback depending upon the degree of flexing with the amount of haptic feedback of one embodiment being proportional to the amount of flexing.

In order to interact with graphical user interface objects in accordance with some example embodiments, a user may further provide a predefined touch input, touch gesture input, and/or the like to one or more graphical user interface objects while flexing the flexible display 118. It will be appreciated that in some embodiments, the order in which the user flexes the flexible display 118 and provides the predefined touch input may not matter. In this regard, a user may, for example, flex the flexible display 118 and subsequently provide one or more touch inputs to a graphical user interface object to navigate through the user interface and/or content. Alternatively, as another example, a user may first provide one or more touch inputs to a graphical user interface object and, subsequently, flex the flexible display 118 to navigate through the user interface and/or content. Further still, in another embodiment of the present invention, a user interface 300 may be configured to prohibit navigation of content or the user interface with a touch input unless the flexible display has been first flexed prior to the user providing the at least one touch input.

In addition to determining that the flexible display 118 has been sufficiently flexed either prior to or following receipt of the user input, the user interface control circuitry 122 may be further configured to receive an indication of and/or otherwise determine a predefined touch input to a graphical user interface object displayed upon a flexible display. In this regard, the user interface control circuitry 122 may, for example, receive a signal indicative of the touch input. This signal may carry information indicative of a type of the touch input, a property of the touch input, and/or the like, thereby enabling the user interface control circuitry 122 to cause the performance of an operation associated with the graphical user interface object based at least in part on the information. The user interface control circuitry 122 may be configured to cause haptic feedback to be provided to a user of the apparatus 102 either in advance of the touch input to facilitate the user's selection of the graphical user interface object or in response to a touch input to provide a positive indication to the user that the touch input has been received.

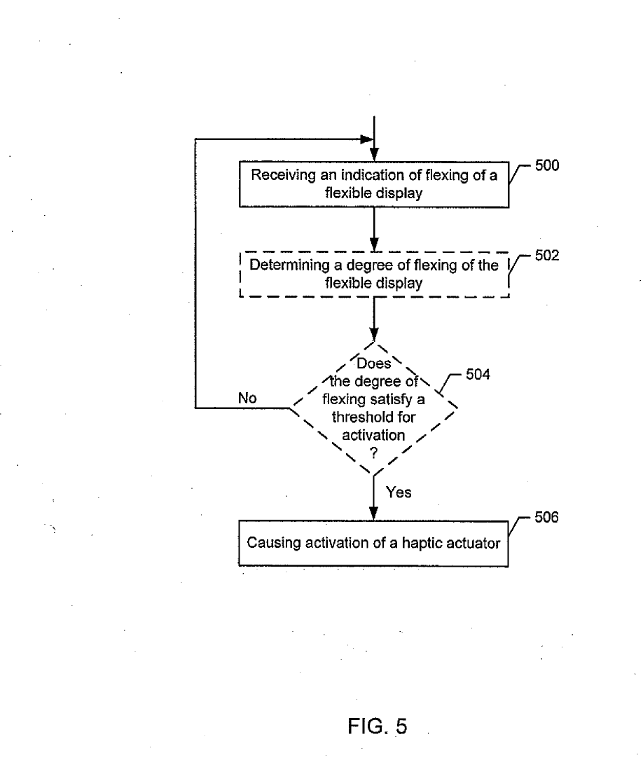

FIG. 5 illustrates a flowchart according to an example method for controlling haptic feedback according to an example embodiment. As described below, the operations illustrated in and described with respect to FIG. 5 may, for example, be performed, with the assistance of, and/or under the control of one or more processor 110, memory 112, communication interface 114, user interface 116, flexible display 118, flex sensor 120, user interface control circuitry 122, or haptic actuator 124. As shown in operation 500, apparatus 102 may comprise means, such as the flex sensor 120, processor 110, user interface control circuitry 122 or the like, for receiving an indication of flexing of the flexible display 118. As in operation 506, the apparatus 102 of this embodiment may also include means, such as the user interface control circuitry 122, the processor 110, the haptic actuator 124 or the like, for causing, in response to flexing of the flexible display, activation of a haptic actuator, thereby providing haptic feedback to the user. The haptic feedback may be provided either in advance of a touch input or following and in response to a touch input. If the haptic feedback is provided in advance of a touch input, the apparatus 102 may also include means, such as the user interface 116, the user interface control circuitry 122, the processor 110 or the like, for receiving a touch input and for associating the touch input with a respective graphical user interface object 302 following provision of the haptic feedback. Alternatively, if the haptic feedback is provided following and in response to a touch input, the apparatus 102 may also include means, such as the user interface 116, the user interface control circuitry 122, the processor 110 or the like, for receiving a touch input and for associating the touch input with a respective graphical user interface object 302 prior to the provision of the haptic feedback such that the haptic feedback in operation 506 is only provided once the touch input has been received. In either embodiment, once the touch input has been received and associated with a respective graphical user interface object 302, the apparatus 102 may include means, such as the processor 110 or the like, for causing the function associated with the graphical user interface object 302 that was selected to be performed.

According to some embodiments, the haptic feedback may be provided in advance of a touch input. For example, a user may flex a flexible display and cause for a graphical user interface object, such as an application icon, to be displayed upon the flexible display in response to the flexing. In some embodiments, the flex sensor 120 may be configured to determine an amount of flexing of the flexible display and display the application icon only when a predetermined amount of flexing has occurred. Concurrently, the haptic actuator 124 may be configured to provide a haptic feedback, such as providing a tactile feedback simulating a raised elevation, at a location proximate to the application icon. In some embodiments, the haptic actuator 124 may comprise a plurality of piezoelectric actuators and may be configured to activate specific piezoelectric actuators disposed proximate to the application icon. Additionally and/or alternatively, the user may provide a touch input to the flexible display proximate the location of the application icon displayed upon the flexible display. As such, the haptic actuator 124 may provide a tactile feedback, such as a vibration, to indicate confirmation of the touch input of the user of the user's selection of the application icon. In some embodiments, the vibration feedback may be a uniform vibration of the entire apparatus 102. According to some embodiments, the vibration feedback may be localized to a particular location, such as a location corresponding to the application icon displayed upon the flexible display. As such, the haptic actuator 124 may be configured to activate selected actuators disposed proximate to the particular location disposed proximate to the application icon and may be further configured to prohibit the activation of actuators disposed elsewhere.

According to one embodiment, the haptic actuator 124 may be configured to provide a textural feedback in response to the flexing of a flexible display 118. For example, a user may be reading an electronic periodical, electronic book, and/or the like displayed on the flexible display 118. The user may flex the flexible display 118 causing an edge of the electronic paper to be displayed upon the flexible display 118. Accordingly, the apparatus 102 may be configured to flip the page of the electronic paper and display a subsequent page in response to a touch input of a user. Specifically, the user may select the edge of the electronic paper and move the edge of the paper from a first position to a second position. In response to the flexing of the flexible display 118, the apparatus 102 may be configured to display an edge of the electronic paper upon the flexible display. Additionally and/or alternatively, the haptic actuator 124 may be configured to provide a tactile feedback, such as a textural feedback simulating the edge of the electronic paper. In some embodiments, the haptic actuator 124 may be configured to provide a raised feedback. For example, the haptic actuator 124 may comprise a plurality of piezoelectric actuators and may be further configured to activate the piezoelectric actuators at a location corresponding to the location of the electronic paper edge displayed upon the flexible display 118. Additionally and/or alternatively, the haptic actuator 124 may be configured to provide a resistance feedback as the user provides a touch input to the flexible display corresponding to moving the edge of the electronic paper across the flexible display 118.

In some embodiments, the haptic actuator 124 may be configured to provide a dampening feedback as the user provides a touch input to the flexible display 118 corresponding to moving the edge of the electronic paper across the flexible display 118. For example, the haptic actuator 124 may be configured to apply a force proximate to the flexible display. Specifically, the haptic actuator 124 may be configured to apply a force proximate to the flexible display at a location where the edge of an electronic paper is displayed upon the flexible display. When a user moves the edge of the electronic paper from a first position to a second position, the haptic actuator 124 may be configured to provide a dampening feedback based at least upon the position of the edge of the electronic paper as the edge moves from the first position to a second position. For example, when a page of the electronic paper displayed upon the flexible display 118 is displayed as being turned, the haptic actuator 124 may be configured to apply a greater force when the edge of the electronic paper is displayed upon the flexible display in a first position away from the subsequent pages of the electronic paper. Additionally and/or alternatively, when the page of the electronic paper is displayed upon the flexible display 118 as being disposed in a resting position upon a subsequent page and the edge of the electronic paper is displayed as being disposed closer to the subsequent page than the first position, the haptic actuator 124 may be configured to provide a smaller force to the flexible display proximate to the edge of the electronic paper displayed upon the flexible display 118. As such, the haptic actuator 124 may be configured to provide a first force to the flexible display 118 disposed proximate to the edge of the electronic paper displayed upon the flexible display that is greater when the edge is displayed as being displaced vertically from subsequent and/or preceding pages of the electronic paper. Accordingly, when the edge of the electronic paper is displayed as being proximate to subsequent and/or preceding pages of the electronic paper, the haptic actuator 124 may be configured to provide a smaller force to the flexible display 118.

In some embodiments, the activation of the haptic actuator 124 in operation 506 is responsive to flexing of a flexible display 118. While any degree of flexing may be sufficient in some embodiments to enable the haptic actuator 124, the apparatus 102 of other embodiments may require that the flexing satisfy a predefined threshold prior to enabling the haptic actuator. As shown by the dashed boxes 502 and 504 in the embodiment of FIG. 5 that are indicative of the optionality of the respective operations, the apparatus 102 of one embodiment may also include means, such as the flex sensor 120, the user interface control circuitry 122, the processor 110 or the like, for determining the degree of flexing of the flexible display and for only causing activation of the haptic actuator 124 in an instance in which the degree of flexing satisfies a predefined threshold.

FIG. 5 illustrates a flowchart of a system, method, and computer program product according to an example embodiment. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving an indication of flexing of a flexible display; and
causing, by a processor and in response to flexing of the flexible display, activation of a haptic actuator.

2. The method of claim 1, further comprising:
determining based at least in part on the received indication of flexing of the flexible display, a degree of flexing of the flexible display.

3. The method of claim 2, wherein causing activation comprises causing activation in an instance in which a threshold for activation of the haptic actuator has been satisfied.

4. The method of claim 2, wherein causing activation of the haptic actuator comprises causing the haptic actuator to provide an amount of haptic feedback that is dependent upon the degree of flexing.

5. The method of claim 1, further comprising receiving touch input of a graphical user interface object, and wherein causing activation of the haptic actuator comprises causing activation of the haptic actuator proximate the graphical user interface object in response to receipt of the touch input.

6. The method of claim 1, further comprising receiving touch input of a graphical user interface object, and wherein causing activation of the haptic actuator comprises causing activation of the haptic actuator proximate the graphical user interface object prior to receiving the touch input.

7. The method of claim 1, wherein causing activation of the haptic actuator comprises causing the haptic actuator to provide at least one of textural, vibration, resistance and dampening feedback.

8. An apparatus comprising at least one processor and at least one memory storing computer program code, wherein the at least one memory and stored computer program code are configured, with the at least one processor, to cause the apparatus to at least:
receive an indication of flexing of a flexible display; and
cause, in response to flexing of the flexible display, activation of a haptic actuator.

9. The apparatus of claim 8, wherein the at least one memory and stored computer program code are configured, with the at least one processor, to further cause the apparatus to:
determine, based at least in part on the received indication of flexing of the flexible display, a degree of flexing of the flexible display.

10. The apparatus of claim 9, wherein the at least one memory and stored computer program code are configured, with the at least one processor, to further cause the apparatus to cause activation of the haptic actuator in an instance in which a threshold for activation of the haptic actuator has been satisfied.

11. The apparatus of claim 9, wherein the at least one memory and stored computer program code are configured, with the at least one processor, to further cause the apparatus to cause activation of the haptic actuator by causing the haptic actuator to provide an amount of haptic feedback that is dependent upon the degree of flexing.

12. The apparatus of claim 8, wherein the at least one memory and stored computer program code are further configured, with the at least one processor, to cause the apparatus to receive touch input of a graphical user interface object, and wherein the at least one memory and stored computer program code are configured, with the at least one processor, to cause the apparatus to cause activation of the haptic actuator by causing activation of the haptic actuator proximate the graphical user interface object in response to receipt of the touch input.

13. The apparatus of claim 8, wherein the at least one memory and stored computer program code are further configured, with the at least one processor, to cause the apparatus to receive touch input of a graphical user interface object, and wherein the at least one memory and stored computer program code are configured, with the at least one processor, to cause the apparatus to cause activation of the haptic actuator by causing activation of the haptic actuator proximate the graphical user interface object prior to receiving the touch input.

14. The apparatus of claim 8, wherein the at least one memory and stored computer program code are configured, with the at least one processor, to cause the apparatus to cause activation of the haptic actuator by causing the haptic actuator to provide at least one of textural, vibration, resistance and dampening feedback.

15. A computer program product comprising at least one non-transitory computer-readable storage medium having computer-readable program instructions stored therein, the computer-readable program instructions comprising program instructions configured to cause an apparatus to perform a method comprising:
receiving an indication of flexing of a flexible display; and
causing, in response to flexing of the flexible display, activation of a haptic actuator.

16. The computer program product of claim 15 configured to cause an apparatus to perform a method further comprising determining based at least in part on the received indication of flexing of the flexible display, a degree of flexing of the flexible display.

17. The computer program product of claim 16
wherein causing activation comprises causing activation in an instance in which a threshold for activation of the haptic actuator has been satisfied.

18. The computer program product of claim 15, configured to cause an apparatus to perform a method further comprising receiving touch input of a graphical user interface object, and wherein causing activation of the haptic actuator comprises causing activation of the haptic actuator proximate the graphical user interface object in response to receipt of the touch input.

19. The computer program product of claim 15, configured to cause an apparatus to perform a method further comprising receiving touch input of a graphical user interface object, and wherein causing activation of the haptic actuator comprises causing activation of the haptic actuator proximate the graphical user interface object prior to receiving the touch input.

20. The computer program product of claim 15, wherein causing activation of the haptic actuator comprises causing the haptic actuator to provide at least one of textural, vibration, resistance and dampening feedback.
